(19) United States
(12) Patent Application Publication
(10) Pub. No.: US 2003/0115240 A1
(43) Pub. Date: Jun. 19, 2003

(54) Schedule managing character and information providing system and method using same

(76) Inventor: Sok-Hyun Cho, Incheon (KR)

Correspondence Address: James P Zeller, Marshall Gerstein & Borun, 6300 Sears Tower, 233 South Wacker Drive, Chicago, IL, 60606-6357, US

(21) Appl. No.: 10/276,284

(22) PCT Filed: May 16, 2001
(86) PCT No.: PCT/KR01/00798

(30) Foreign Application Priority Data
May 16, 2000 (KR) 2000/26023
Jun. 29, 2000 (KR) 2000/36644
Dec. 20, 2000 (KR) 2000/79347

(51) Int. Cl. G06F 9/00

(52) U.S. Cl. 709/102; 709/203

(57) ABSTRACT

Disclosed is a schedule managing character and information providing system and method using the character. When at least one user terminal accesses the information providing system via a network, the system connects a character to perform the data. The information providing system generates data for operating the character during a predetermined time frame, provides the data to the character via the user terminal to manipulate the character, and receives the user's reaction data generated according to the character's motion via the user terminal. Therefore, the present invention enables the user to raise the character, satisfies the user by providing various kinds of information desired by the user via the character, periodically updates the contents configuration via the human-friendly character, stores the data needed by the user, and enables interactive information communication.

### BACKGROUND OF THE INVENTION

(a) Field of the Invention

The present invention relates to a character and a system for coupling the character to a user terminal. More specifically, the present invention relates to a character for displaying a user terminal's various data receipt and use states, and a system and method for providing information using the character.

(b) Description of the Related Art

Conventional toys are not interactive, and most toys are simply operated according to users' manipulation. To avoid this simplicity, some toys are sold with a built-in system enabled to create human voices or to be operated according to items selected by a person.

However, when a buyer buys the conventional toy, the toy system is previously affixed and manufactured by toy makers, and accordingly, the toy have neither any expandable toy functions nor maintenance.

In other point of view, when receiving data such as a terminating call, mail, text or voice, a mobile communication wireless terminal such as a cell phone, PCS or IMT-2000 notifies the user of data receipt via melody or an icon provided respectively by a buzzer or a display. In addition, when the automatically outputs a predetermined melody via a buzzer and informs the user on the established day and time.

As described, since the above-noted functions are applied to most mobile phones, the mobile phones have almost identical functions and accordingly they do not have distinctions.

Various functions such as information exchange and game using the Internet or wireless infrared-ray communication (IrDA) between personal computers or mobile phones are applied to the mobile phones according to the mobile phone users' requests. These functions are boring to users in spite of their functional excellence because the users use them on the mobile phones, and hence, they cannot fully satisfy the users' desires.

### SUMMARY OF THE INVENTION

It is an object of the present invention for a user to nurse a character and provide various kinds of information selected by the user to the user via the character to satisfy the user.

It is another object of the present invention to continuously update contents configurations via a human-friendly character, save data needed by the user and performing bi-directional information exchange.

It is still another object of the present invention to connect a peripheral device such as a doll to a wireless terminal via a network, selectively receive information such as news, current topics, entertainment, game and learning from a server according to unique features of the peripheral, and provide the information to a user in real time via the peripheral or respectively operating it by a built-in program so as to more effectively use the wireless terminal.

It is further another aspect of the present invention to periodically download operation programs of peripherals connected to a wireless terminal and various categories of life information and update them, thereby giving a growth concept and life to the peripherals and activating wireless terminal markets.

In one aspect of the present invention, a character connected to a user terminal, a manager terminal, a connection server and a data storage server through a network, comprises: a connector for receiving and interfacing one or more kind of task event information from the user terminal; a memory storing operation information of the character transmitted by the connector, and user response result data to the character; a character controller controlling execution of the task event stored in the memory, and uploading the user response result data stored in the memory through the connector; and a driver representing the task event data responsive to a control signal of the character controller.

The memory comprises: a file allocation table storing formal file allocation table in one or more blocks; a variable region storing variables in one or more blocks; an interrupt index storing an interrupt, a test event index and a game event table in one or more blocks; an event table downloading and storing a unit event corresponding to a predetermined period in a first mode; a wave stream storing a voice file corresponding to the period in the first mode; a temporary table field downloading and storing one or more unit events in a second mode; a temporary wave stream field downloading and storing one or more wave voice files in the second mode; and a residual region prepared for abnormal states of each storage region of the memory.

In another aspect of the present invention, an information providing system connected to one or more user terminals through a network, providing data to the user terminal to operate responsive to the provided data, comprises: a manager terminal supporting one or more data inputs for the user to receive schedule management information and additional information through the character; a character management server providing the schedule management information and additional information to the user terminal through the network, receiving user's action data responding to the character and processing the received data; and an information storage server storing character's operation and one or more event data for the character's operation.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a mobile phone coupled to a character according to a first preferred embodiment of the present invention;

FIG. 2 shows an internal circuit of the mobile phone and the character of FIG. 1 according to the first preferred embodiment of the present invention;

FIG. 3 shows an internal circuit of a wireless transmitter of FIG. 2;

FIG. 4 shows an internal circuit of a wireless receiver of FIG. 2;

FIGS. 5(a) and 5(b) show internal circuits of a wireless interface of FIG. 2;

FIG. 6 shows a displayed screen of a greeting setting mode of a character;

FIG. 7 shows a flowchart of an operation of the mobile phone and the character of FIG. 2;

FIG. 8 shows a flowchart of a self-operation of the character of FIG. 2;

FIG. 9 shows an exemplified sketch for describing the preferred embodiment of the present invention;

FIG. 10 shows a block diagram of an information providing system according to a second preferred embodiment of the present invention;

FIG. 11 shows a detailed block diagram of a character of FIG. 10;

FIG. 12 shows an internal configuration of the character of FIG. 11;

FIGS. 13(a) and 13(b) shows configurations of a memory of FIG. 12;

FIG. 14 shows a sequence for finding a wave stream of FIGS. 13(a) and 13(b);

FIG. 15 shows a screenshot of a window for editing voices using an event editor;

FIGS. 16(a) and 16(b) show screenshots of windows for editing an event unit using an event editor;

FIGS. 17(a) to 17(e) show screenshots of windows for editing tasks using an event editor;

FIG. 18 shows a flowchart for downloading and uploading information according to the second preferred embodiment of the present invention;

FIG. 19 shows a flowchart of an information providing method using a character according to the second preferred embodiment of the present invention; and

FIGS. 20(a) to 20(f) show an exemplified execution of a user program for a user to manage the user's schedule.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

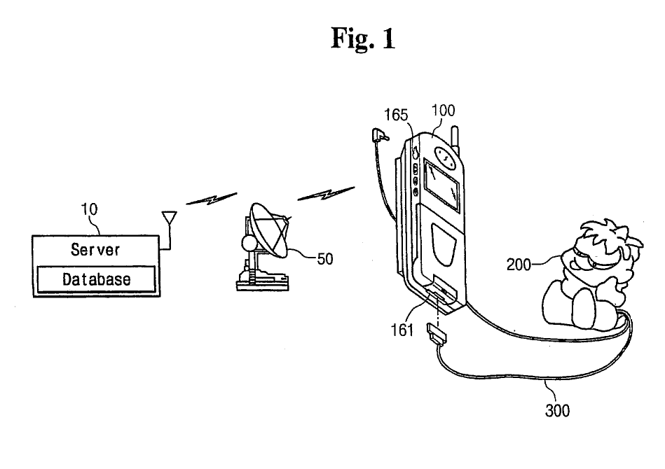

FIG. 1 shows a mobile phone coupled to a character according to a first preferred embodiment of the present invention. A character having a built-in control circuit and an input/output device, is coupled to a data communication terminal 161 or a earphone/microphone terminal 165 of a mobile phone 100 via a communication cable 300, or wirelessly communicates with it.

As shown, the character 200 such as a doll is one of peripherals coupled to the mobile phone 100, and is totally different from a hands-free set coupled to the mobile phone 100 or a personal digital assistant (PDA) in its concept.

That is, the hands-free set simply inputs and outputs voices, and the PDA uses the mobile phone as a modem.

The character 200 as a peripheral coupled to the mobile phone 100 has its own personalities such as studying, singing, playing games and sports, traveling, reading books, enjoying leisure, laughing, weeping or sleeping much, and a unique voice in connection with the personalities.

That is, each character has its unique features, and the character's voice output program and various categories of information provided by a server 10 is operated by consistently receiving information relating to the character's unique personalities.

As described, by coupling the character 200 to the mobile phone 100, the data such as telephone signals, text, voice and mail are transmitted to the mobile phone or are output in a unique voice established to the character 200 when setting a timer or an alarm.

Also, the mobile phone's receipt states of the data can be displayed by blinking a light emitting diode (LED) attached to the eyes of the character or using a vibrator along with the character's voice output.

As described, the character 200 attached to the mobile phone 100 can be operated according to the data provided via the mobile phone or by the character 200 in no connection with the operation of the mobile phone, and a self-operating program can be updated by periodical downloading from the server 10.

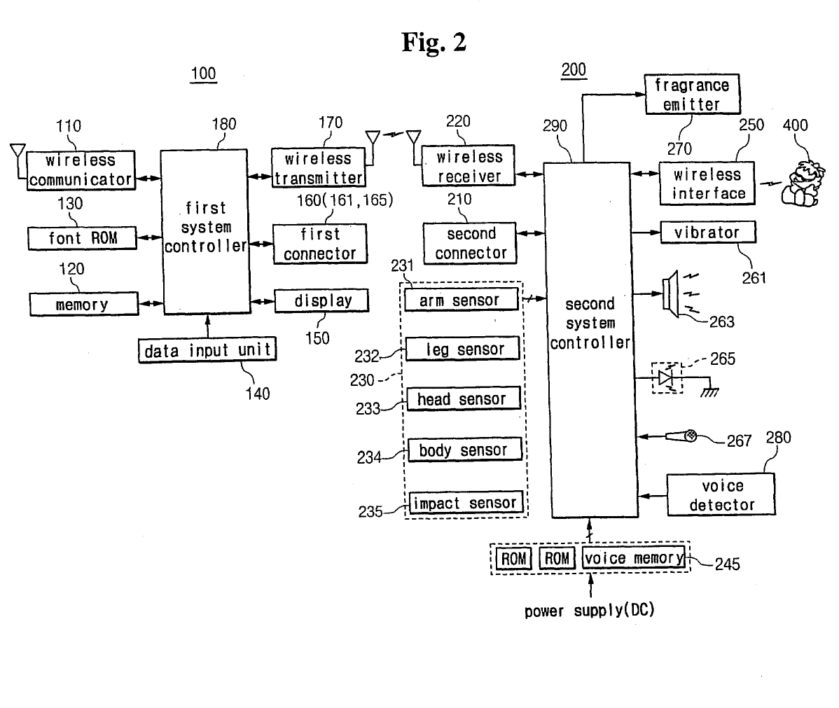

FIG. 2 shows an internal circuit of the character and the mobile phone of FIG. 1. The mobile phone 100 comprises a wireless communicator 110, a memory 120, a font read only memory (ROM) 130, a data input unit 140, a display 150, a first connector 160, a wireless transmitter 170 and a first system controller 180. The character 200 comprises a second connector 210, a wireless receiver 220, a body sensor 230, a memory 240, a wireless interface 250, a plurality of input/output units 261 to 267, a fragrance emitter 270, a voice detector 280 and a second system controller 290.

The wireless communicator 110 is a modulator/demodulator for communicating with the server 10 via a predetermined base station 50 of FIG. 1 and receiving the character's operation program or various kinds of information. The memory 120 stores a terminals identification number, various operation programs and user setting information. The font ROM 130 stores letter data for respective language codes such as Korean, English, Japanese and Chinese. The data input unit 140 includes the character's operation mode keys and other keys for setting the character's operation states and various functions. The display 150 displays the information provided by the server 10 in text, or displays the character's various modes, input instructions, operation states and optional functions according to the data input unit's key selection.

The first connector 160 is a data communication terminal 161 or a earphone/microphone terminal 165 of the mobile phone, is coupled to the character 200 via a predetermined communication cable 300 so as to output control signals output by the first system controller 180 to the character 200. The wireless transmitter 170 transmits the information provided by the server to the character 200.

The memory 240 comprises a ROM 241, a random access memory (RAM) 242 and a voice memory 243. The voice memory 243 stores voice signals (or voice data) per table to execute at least one event.

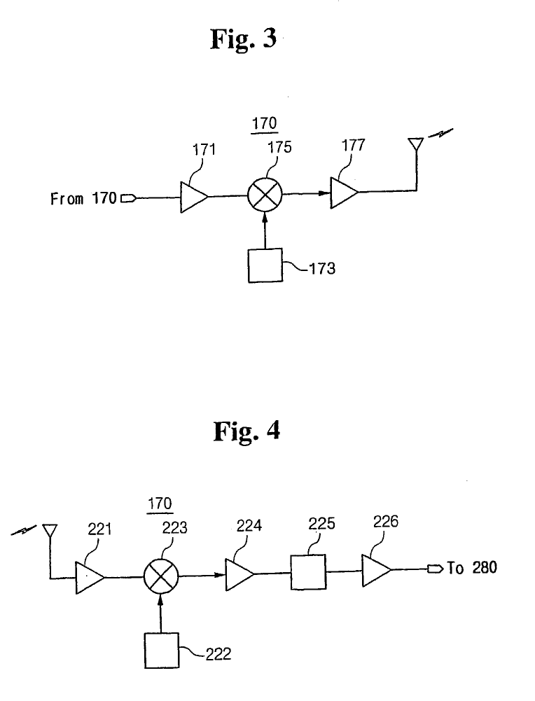

The wireless transmitter 170 as shown in FIG. 3 comprises a voice signal amplifier 171 for amplifying and adjusting the voice signals, a local signal oscillator (PLL) 173 for generating predetermined local signals, a modulator 175 for combining the voice signals output by the voice signal amplifier 171 with the local signals output by the local signal oscillator 173 and modulating them to RF signals, and a power amplifier 177 for amplifying the voice signals output by the modulator 175 and transmitting them via an antenna.

The first system controller 180 controls the whole system's operation, and when receiving information on the character 200 or instructions on the character operation mode from the wireless communicator 110 or the data input unit 140, the first system controller 180 controls the character 200 to perform corresponding actions.

The second connector 210 of the character 200 coupled to the first connector 160 receives information output by the mobile phone 100 and outputs it to the second system controller 290. The wireless receiver 220 as shown in FIG. 4, comprises a radio frequency (RF) amplifier 221 for amplifying RF signals input via a receipt antenna, a local signal oscillator 222 (PLL) for generating predetermined local signals, an intermediate frequency (IF) converter 223 for combining the voice signals output by the RF amplifier 221 with the local signals output by the local signal oscillator 222 and converting them to fit IF signals appropriate for detection, an amplifier 224 for amplifying the voice signals converted by the IF converter 223, a detector 225 for detecting original voice signals from among the voice signals output by the amplifier 224, and a low frequency amplifier 226 for amplifying the voice signals output by the detector 225.

The second system controller 290 receives information from the second connector 210, determines instruction data, and stores them in a memory 240 according to results or selectively reads the voices previously stored in the voice memory 245 and outputs the same via a voice output unit 263 such as a speaker.

The second system controller 290 receives the data output by the mobile phone 100 via the second connector 210 or the wireless receiver 220, determines the data, and stores a predetermined portion of them in the memory 240, or reads stored voice data, outputs a unique voice and controls the fragrance emitter 270 according to a received message so as to emit fragrance.

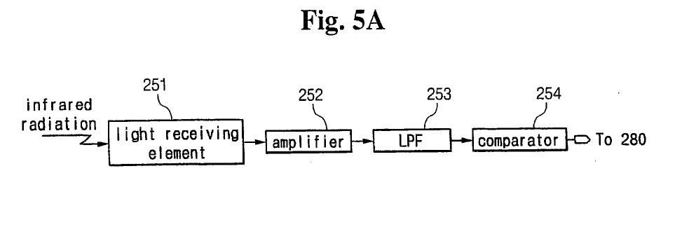

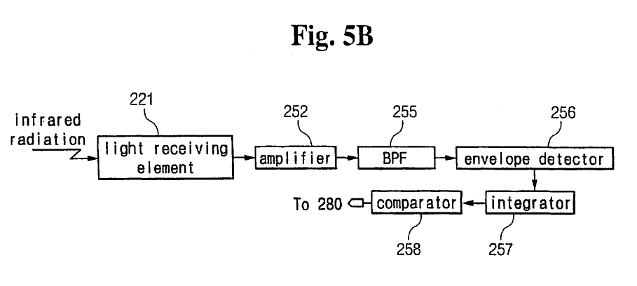

The wireless interface 250 is a communication interface for transmitting and receiving programs and various kinds of information stored in an adjacent character 400 and the memory 240 according to the control signals of the second system controller 290. FIG. 5 shows its detailed circuit, FIG. 5(a) showing a block diagram of a base band method of an infrared-ray communication and FIG. 5(b) showing a block diagram of a subcarrier method of the infrared-ray communication.

The infrared ray communication is categorized as the base band method and the subcarrier method according to modulation methods. The base band method directly emits the infrared rays or not according to the data to be transmitted, and the subcarrier method demodulates the subcarriers according to the data to be transmitted.

As shown in FIG. 5(b), the wireless interface 250 by the subcarrier method comprises a band-pass filter (BPF) 255, an envelope detector 256, an integrator 257 and a comparator 258. Since the BPF 255 filters band signals of about 500 KMz, the subcarrier method has strong noise characteristics against the sun light and incandescent beams of DC noises and a fluorescent light of AC noises, but its circuit is more complicated that the bas band method, and hence it costs more.

Since the base band method uses a low pass filter (LPF) 253, the noise characteristic can be improved by increasing the light emitting intensity of a light emitting element or reducing receiving sensitivity of a light receiving element so as to remove the external DC and AC noises.

With reference to these characteristics, a desired type of the infrared-ray communication circuit can be adopted under the present's use environments, and the RF method of FIGS. 3 and 4 can also be adopted depending on the users.

Also, the Bluetooth method adopting the data transmission speed of 1 Mbps, the transmission distance of 10 to 100 m, the frequency band of 2.4 GHz, the consumption power of below 100 mW at 2.7V can be used. The Bluetooth method is more excellent than the infrared-ray communication method having the communication distance of 1 to 2 m and being weak in the noise, but it is better to delay its application to mass production because of its production cost.

A microphone 267 of FIG. 2 is a microphone, and when a call is generated, the second system controller 290 operates a predetermined sensor of the sensors 230 installed in the character and controls to call using the character and to make a hands-free call via the microphone 267 and the speaker 263. The voice detector 280 of FIG. 2 detects the user's voice, compares it with the voice data previously stored in the memory 241, and automatically generates a call according to a corresponding telephone data.

The character 200 has a charging connector on a side of the character 200 in the like manner of the mobile phone 100, receives AC power via an adapter, charges a power supply, and supplies the voltage to the respective components of the character 200. It is preferable to use the secondary AC-charged power rather than the primary DC power in consideration of the character's weight and size.

The mobile phone 100 and the character 200 can transmit the data to the server 10 in a file or a stream format using the WAP or ME standard. It is preferable to transmit the character's operation program in the file format, and the real-time information in the stream format.

The server 10 supports Korean letters and voice, and if needed, also supports English, Japanese and Chinese so that the server 10 can display the corresponding letters using the data stored in the font ROM 130 installed in the mobile phone.

Formats of the data transmitted by the server 10 include telephone number codes, information category (terminating call, voice/text message and mail) and data codes (text and voice), and the number of the bits of the respective data codes can be established according to used information.

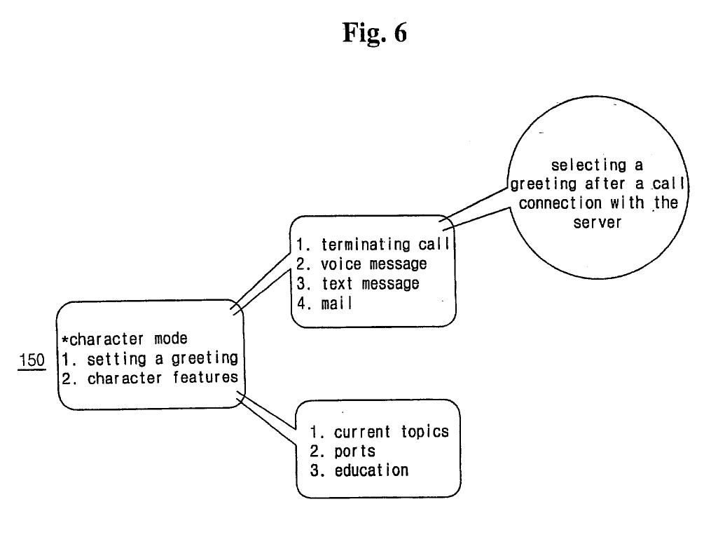

Greeting messages and personalities of the character 200 can be downloaded to the memory 240 from the server 10. As shown in the display screen 150, of FIG. 6, when the user uses a character mode selection key provided on the data input unit 130 of the mobile phone 100, sequentially searches a category screen from the main screen to subsequent sub-screens, and selects desired greeting and personality of the character 200, the user is automatically connected to the server to receive a corresponding unique and interesting voice and store it in the memory of the character, and therefore, the user can set the unique greeting and personalities according to the received data.

For example, if the user selects the ‘learning’ for the character's personality, the switched personality of the character is registered to the server and accordingly, the user periodically receives additional information related to the learning.

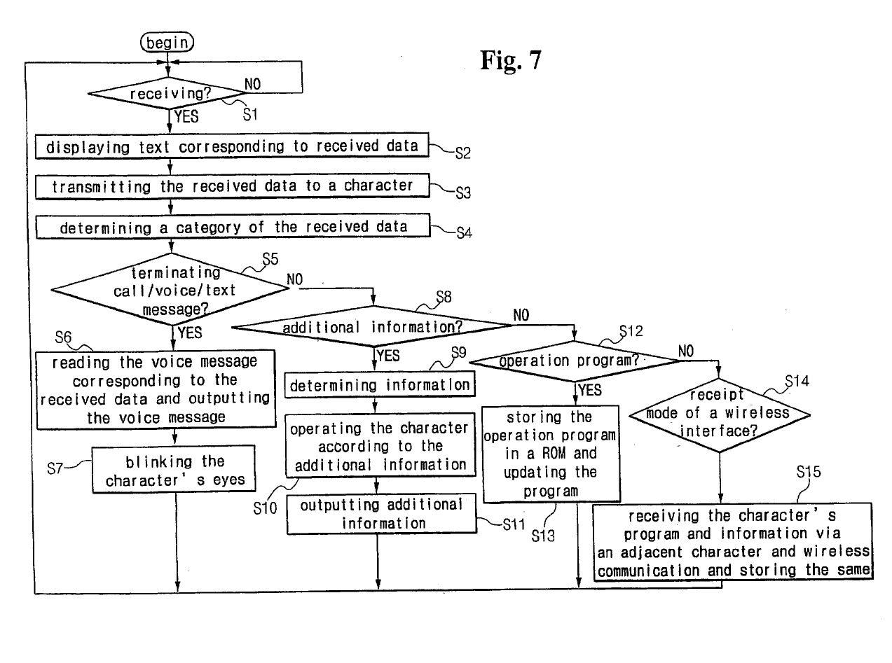

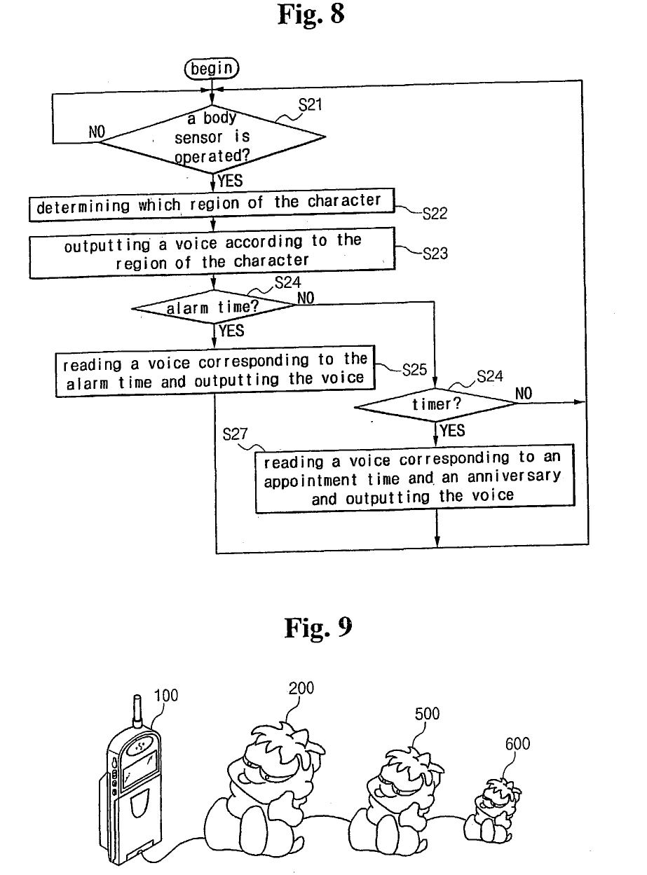

FIG. 7 shows the case that the mobile phone 100 and the character 200 receive information from the server 10 via the base station 50 and perform their operation, and FIG. 8 shows the character's operation.

When various greeting messages and voice information are previously stored in the voice memory 245 of the character 200, and the data corresponding to the terminating call/short messages/voices and call messages/mail (additional information and programs) are transmitted to the mobile phone 100 in step S1, the first system controller 180 determines whether the input data includes the letter data, and when the letter data are found, the first system controller 180 reads the letters corresponding to the letter codes from the font ROM 130, displays the letters of the corresponding language such as the Korean, English, Japanese and Chinese on the display 150 in step S2, and transmits the voice, display data and additional information to the character 200 via a cable of the first connector 160 or a wireless cable of the wireless transmitter 170 in step S3.

That is, when transmitting the input data to the character 200, the first system controller 180 determines the category of the input data and performs appropriate controls, and when the data to be displayed on the mobile phone 100 are found from among the transmitted data, the first system controller 180 controls the data to be displayed on the mobile phone 100 in predetermined letters, and when the data to be transmitted to the character 200 are found, the first system controller 180 transmits them to the character 200 via the cable or the wireless cable.

The character 200 receives the character-related data and determines the data codes in step S4, and when the input data are found to be those of the terminating call, the character 200 displays the data related to the terminating call on the display 150 of the mobile phone 100, repeatedly switches on and off the LED 265 provided to the eyes of the character 200 according to the terminating call, reads the corresponding voice from the voice memory 245, and notifies a receipt of a voice message via the speaker 263 in steps S5 to S7.

When the input data are found to be the additional information of the character 200, the character 200 determines the additional information and outputs a corresponding voice or repeatedly switches on and off the LED 265 in steps S8 to S11, and when input data are found to be the character's operation program, the character 200 stores it in the ROM 241 to update the previous operation program, and the second system controller 290 controls the operation of the character 200 according to the operation program in steps S12 and S13.

The data corresponding to the additional information S1 is in the following table.

Table 1 shows an exemplified data format of the additional information provided by the server 10. The additional information includes a telephone number code, information category, and action data codes. The actions of the letters and the character, displayed on the screen of the mobile phone are different according to the data codes.

TABLE 1

| | Inform- | Data | | | |
|---|---|---|---|---|---|
| Telephone | ation | code | state | Actions by data | |
| | | | | Mobile | character |
| | | | | phone | |
| 016208999 | S1 | OT001 | hungry | Displaying | Displaying a |
| | | | | a dinner | hungry |
| | | | | menu | comment and |
| | | | | | blinking the |
| | | | | | LED |
| 016208999 | S1 | OT003 | sleepy | Displaying | Displaying a |
| | | | | pajamas | sleepy |
| | | | | | comment and |
| | | | | | blinking the |
| | | | | | LED |

As shown in Table 1, a dinner menu is displayed on the display 150 according to the hungry state code, and the user selects a desired menu via a key manipulation, and accordingly, a cyber dinner is provided to the character 200 and the server 10 periodically collects the dinner had by the character 200 to detect the character's nutritional states and provide the states to the character 200.

When the user enters the menu using a key 140 of the mobile phone 100, and sets the wireless interface 250 in the receiving mode as shown in FIG. 6, the program stored in the opponent character 400 and information (voice) of the character 400 are received via the wireless interface 250 and stored in the memory 240 in steps S14 and S15.

The fragrance emitter 270 is installed in the mouth of the character 200, and emits fragrance when a message or mail is transmitted from the server 10.

Differing from this, the character 200 can operate according to the program stored in the ROM 241, and the second system controller 290 of the character 200 determines whether sensing signals are detected from the sensors 230 installed in the body's respective regions in step S21.

When the sensing signals are detected, the second system controller 290 determines the regions of the character, reads a voice corresponding to the region from the voice memory 245, and outputs the voice in steps S22 and S23.

For example, when the user touches the character's nape, the character says, “Oh, I feel ticklish,” and when the user touches its hand, it says, “I love you,” and when the user shocks the character, it says, “I feel dizzy,” according to the previously established program. In this instance, the previously established voices can be differently output for the different regions of the body, or the plural voices can be sequentially repeated and output in no connection with the regions.

The user can set alarming time and messages via the data input unit 140 of the mobile phone, and accordingly, when it comes to the alarming time, the second system controller 290 reads the corresponding voice from the voice memory 245 and outputs the same in steps S24 and S25.

The user can also set appointments or anniversaries via the data input unit 140, and accordingly, when it comes to the corresponding time, the second system controller 290 reads the corresponding voice from the voice memory 245 and outputs the same in steps S26 and S27.

Therefore, the user can use the mobile phone interestingly.

Various voices are stored in the voice memory 245 of the character 200, and the user can also download the voices to the memory 240 of the character 200 in the like manner of downloading bell melodies from the server 10.

FIG. 9 shows another preferred embodiment of the present invention. By connecting the character 200 with a plurality of other characters 500 and 600 and providing identification numbers of different codes to the characters 500 and 600, the characters 500 and 600 can be defined as a family such as father, mother, brother and sister, and can receive different additional information and operation programs from the server 10 according to their functions and ages, and the characters 500 and 600 can share identical data via wire or wireless communication between them.

A character and an information providing system using the character according to a second preferred embodiment of the present invention will now be described.

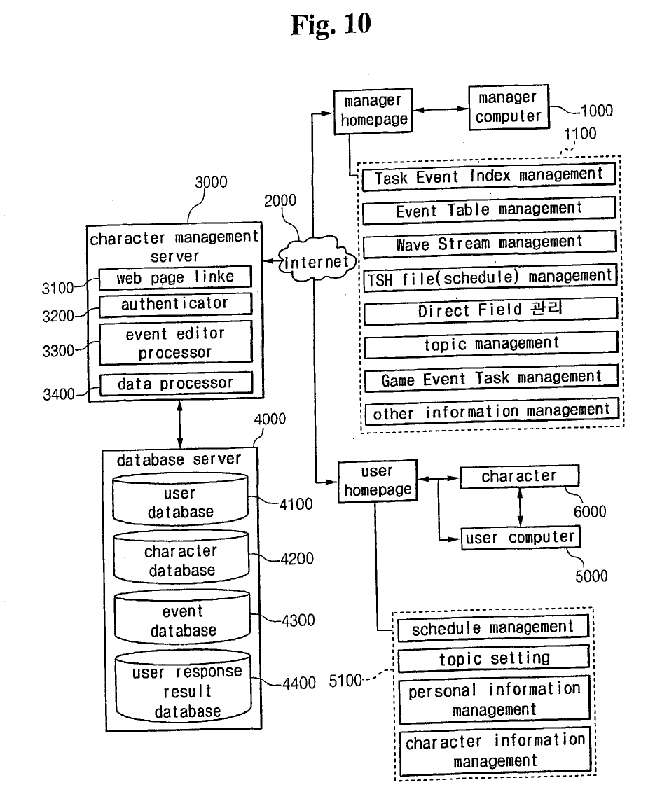

FIG. 10 shows an information providing system according to the second preferring embodiment.

As shown, the information providing system comprises: a character 6000 for providing information desired by the user according to at least one action and exchanging information accumulated via the user's response; a user computer 5000 for managing the schedule, personal information and character information according to the user's desires; a manager computer 1000 for supporting data inputs so that a user may receive schedule management services and additional information via the character 6000; a character management server 3000 for providing the schedule management and additional information to the user computer 5000 via the Internet 2000, receiving the user's action results in response to the character 6000, and processing data; and a database server 4000 for storing the character's motion and at least one event data for operating the character.

The manager computer 1000 includes an event editor 1100 that is a control routine program for the character's operation.

The event editor 1100 comprises: a task event index manager for generating contents of task event index fields, modifying them and removing them; a wave stream manager for continuously generating voice contents of wave files, modifying them and removing them; an event table manager for generating data of the event table based on the generated wave streams, modifying the data and removing them; a TSH file manager for selecting a task event index, an event table and wave streams to be used for each day, combining them into a single file, and setting a service time when providing a daily schedule and other information; a direct field manager for managing the contents executed in a direct access mode; a topic manager for adding, modifying and removing the contents corresponding to a predetermined topic, and enabling them to be amended by a user after a basic time setting; a game event table manager for generating, modifying and removing game contents so that the user may manage the user's schedule via games and receive other information; and an additional information manager.

The character management server 3000 comprises: a web page linker 3100 for receiving at least one web page request signal from the manager computer 1000 or the user computer 5000 connected via the Internet 2000 and displaying a corresponding web page to the manager computer 1000 or the user computer 5000; an authenticator 3200 for authenticating the access request by a manager or a user; an event editor processor 3300 for receiving data setting information established by the event editor 1100, processing the information, and providing processing results to the manager computer 1000; and a data processor 3400 for calling the database server 4000 according to the results processed by the event editor processor 3300, storing the established data, and calling information stored in the database server 4000 when the information is requested.

Respective units of the character management server 3000 can be independent devices for respectively performing their functions, or can be a single device that integrates the functions of the units, which are not restricted to the preferred embodiment of the present invention.

The database server 4000 comprises: a user database 4100 for storing perception information and detailed information of the user who possesses at least one manager or a character 6000; a character database 4200 for storing information on the characters classified according to serial numbers each of which being provided to a character; an event database 4300 for managing the schedule for the characters' operation and storing other information providing data; and a user response result database 4400.

The respective databases of the database server 4000 can be independent information storing media, or can be integrated into a single database by configuring each database in a separate table, which are not restricted to the preferred embodiment of the present invention.

The user performs a schedule management for directly managing the personal schedule via the user homepage and downloading the created schedule to the character 6000 so that the character may notify and manage corresponding schedules and help promote regular life patterns, a personal information management for receiving desired contents according to the user's tendency, a character information management for measuring predetermined indexes using information provided via the character 6000 and estimating them, and a topic management for directly selecting a desired topic by the user and modifying the character's operation time.

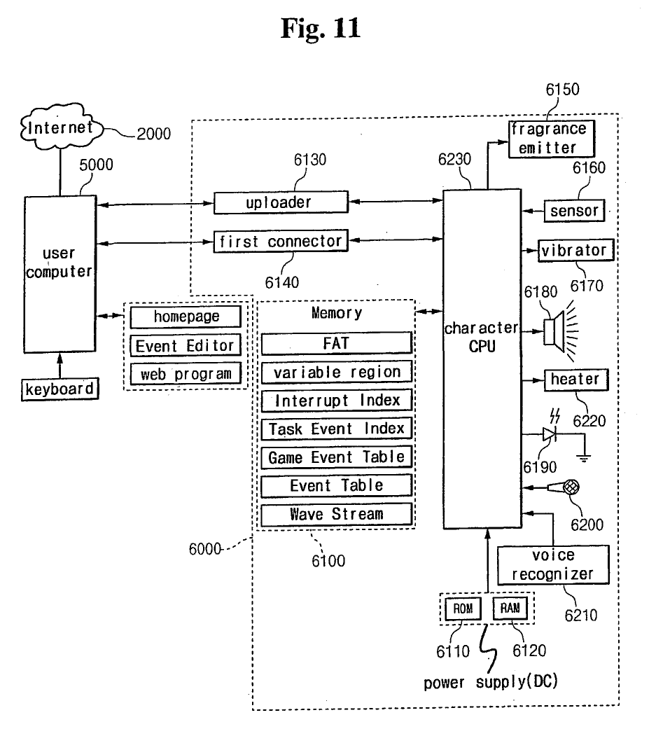

FIG. 11 shows a detailed block diagram of the character of FIG. 10.

As shown, the character 6000 comprises: a memory 6100 for storing data for performing events; a ROM 6110 for storing data needed for the character's identification number and operation; a RAM 6120 for temporarily storing control signals for controlling the character's operation corresponding to the event, and temporarily storing response result data of the user's events; an uploader 6130 for uploading the response result data to the user computer 5000; a first connector 6140 for enabling to upload the response result data and other data set by the user program; a fragrance emitter 6150 for emitting fragrance via the character's nose; at least one sensor 6160 for sensing brightness, darkness, heat and shocks (e.g., a optical sensor, a heat sensor or other types of sensors) so as to detect neighboring environments; a vibrator 6170 for outputting the character's response results via vibration; a speaker 6180 for outputting a voice caused by the wave stream; an LED 6190 for generating blinking signals through the character's eyes; a microphone 6200 for catching the user's voice signals caused by the characters operation; a voice recognizer 6210 for reading the voice signals input via the microphone 6200; a heater 6220 for generating heat so that the user may feel it; and a character central processing unit (CPU) for controlling the character's whole operation.

The user computer 5000 comprises: a downloader for downloading at least one event data; and a second connector for enabling to download task information needed for the character's operation.

The first connector 6140 can upload and download data, and can also be connected to a data communication terminal, an earphone terminal or a microphone terminal of the user's mobile phone (which are not illustrated), which are not restricted to the preferred embodiment of the present invention.

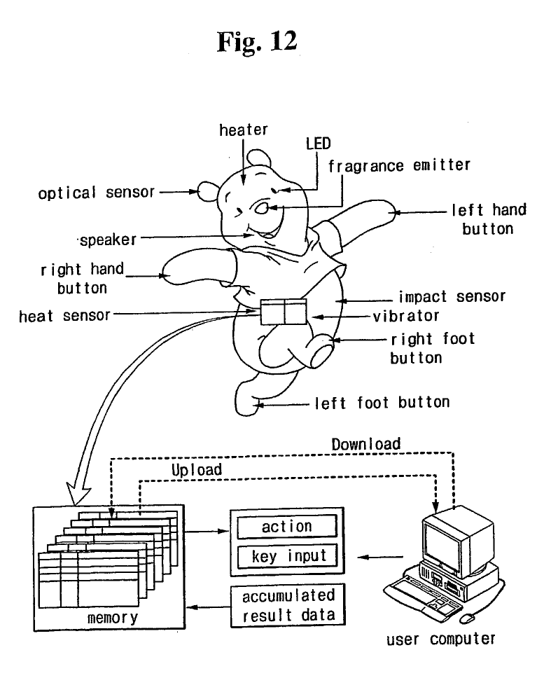

FIG. 12 shows an internal configuration of the character of FIG. 11.

The character 6000 comprises an optical sensor, an LED, a speaker, a fragrance emitter, a heater, a right hand button, a left hand button, a heat sensor, an impact sensor, a vibrator, a left foot button and a right foot button.

The optical sensor responds in three steps according to the brightness and darkness of light. The LED blinks each time the character speaks. The speaker outputs the voice signals stored in the memory. The fragrance emitter emits at least one kind of fragrance through the character's nose.

The right and left buttons respond to the user's voice transmitted via the speaker. That is, the buttons enable to answer to questions, switch the sensors on and off, play games, change modes and listen to English. The heat sensor responds to current temperature in three steps. The impact sensor detects the impacts provided to the character from the outside to check neighboring environments. The vibrator outputs the character's response results via vibration. The right and left foot buttons adjust topics hearing, games and sound volume. The heater outputs heat so that the user may check the character's states. For example, when the character 6000 is left alone in a space of low temperature for more than a predetermined time, and the temperature detected by the heat sensor is found to be less than a predetermined temperature, the, character CPU 6230 controls the heater to be operated, and accordingly, it is implicitly displayed that the character 6000 have a cold and a fever, and the vibrator is vibrated to provoke the user to respond to the character 6000, and the user can feel the heat caused by the heater on the forehead of the character 6000.

The character has a built-in memory for downloading schedule information from the user computer, storing it, enabling the user to hear a daily schedule as a voice, storing the user's accumulated actions, and enabling the user computer to upload the accumulated result data.

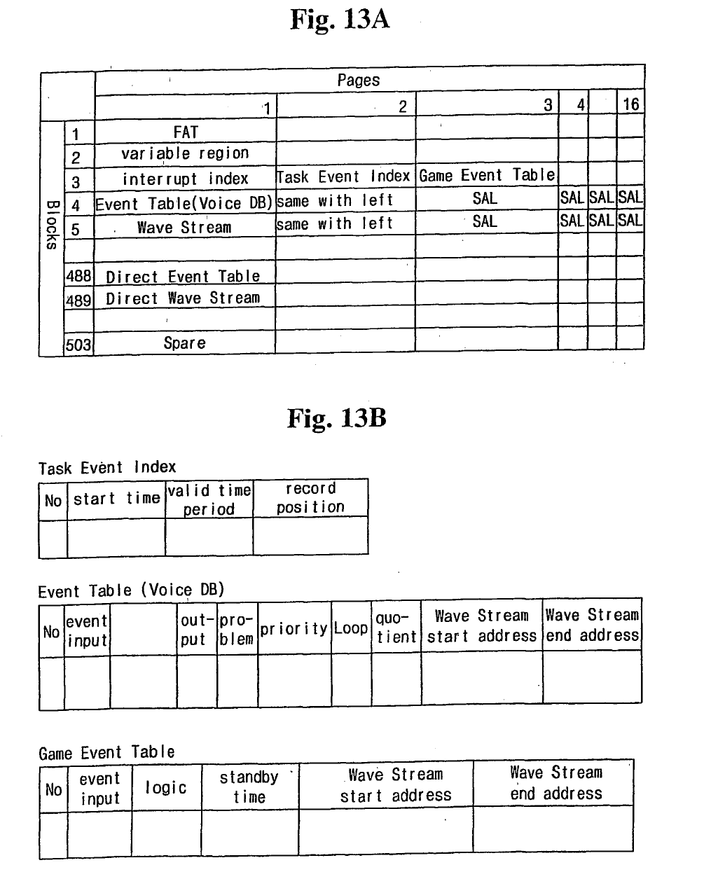

FIGS. 13(a) and 13(b) show a configuration of the memory of FIG. 12.

As shown in FIG. 13(a), the memory 6100 comprises a formal file allocation table (FAT) for storing a one-page FAT in a block; a variable region for storing a one-page variable in a block; an interrupt index for storing one-page interrupts, one-page test event indexes and one-page game event tables; an event table (voice database) for downloading one-day unit events from the active mode and storing them; a wave stream for storing one-day wave-format voice files in the active mode; a temp table field (or a direct event table) for downloading a unit event in the direct access mode (where a character is connected to the user computer) and storing it; a temp wave stream (or a direct wave stream) for downloading a wave file in the direct access mode and storing it; and a residual region for preparing against errors generated in the above storage spaces.

The FAT provides locations of clusters that store files. The active mode represents a mode for bi-directionally exchanging information between the character 6000 and other system. The direct access mode indicates a mode that the character functions as a peripheral device for outputting signals transmitted by the user computer 1000 under the state that the user computer is connected to the character 6000.

FIG. 13(b) shows a configuration of a data generation table. The data generation table is stored-in the memory 6100 per table so as to execute events, and each table has its own information and executes the events in a predetermined order.

The task event index includes an address number, a start time, a valid time period and a record position, and when the character starts an event according to the start time, it moves during the valid time period of the task event index table, and it goes to the record position of the event table (the voice database).

The event table includes an address number, an input (event), a standby time, an output, a problem, a priority, a loop, a quotient, a wave stream start address and a wave stream end address. The event table executes various data stored via the input and output at the record position provided by the task event index table to find the start and end address numbers of the wave stream and perform the voice file.

The game event table includes an address number, an input (event), logic, a standby time, a wave stream start number and a wave stream end number. When the user reacts to the character, the game event table receives response input data, converts an input key into a logic value, stands by during a predetermined standby time, finds an event, the start and end address numbers of the wave stream, outputs a voice comment and performs the game.

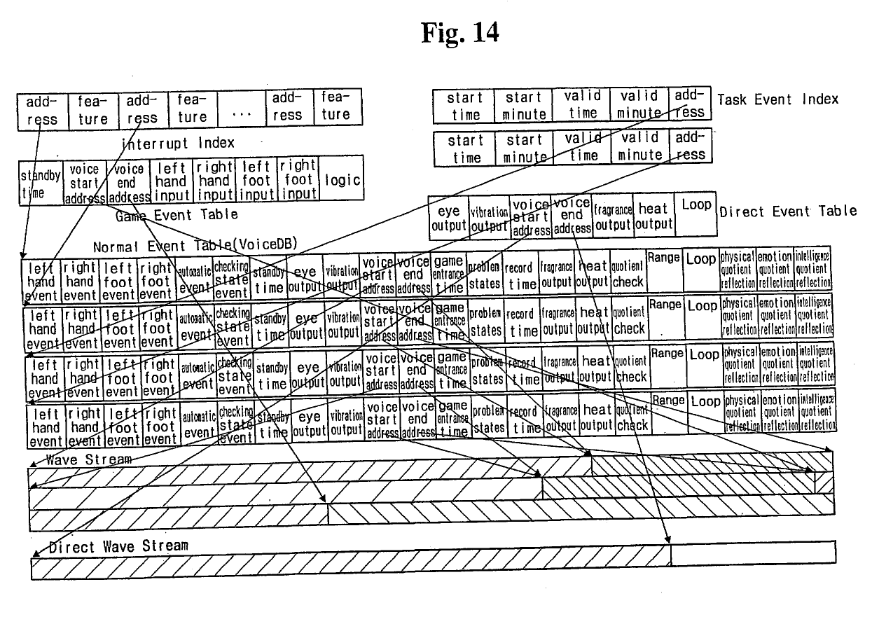

FIG. 14 shows a sequence for finding the wave stream of FIG. 13.

As shown, when an initial task event is executed based on the data set by a manager via the event editor 1100, it moves to an address of the interrupt index, and a voice file is performed according to the start and end address numbers of the wave stream based on the data stored in the event table (the voice database). If the wave stream does not exist in the interrupt index, it moves to the record positions of the task event table, the game event table and the direct event table, and them moves to the addresses of the assigned wave streams of the task event table, the game event table and the direct event table, and the corresponding voice file is executed by the start and end address numbers of the wave stream.

An operation of the information providing system using a character according to the second preferred embodiment of the present invention will now be described.

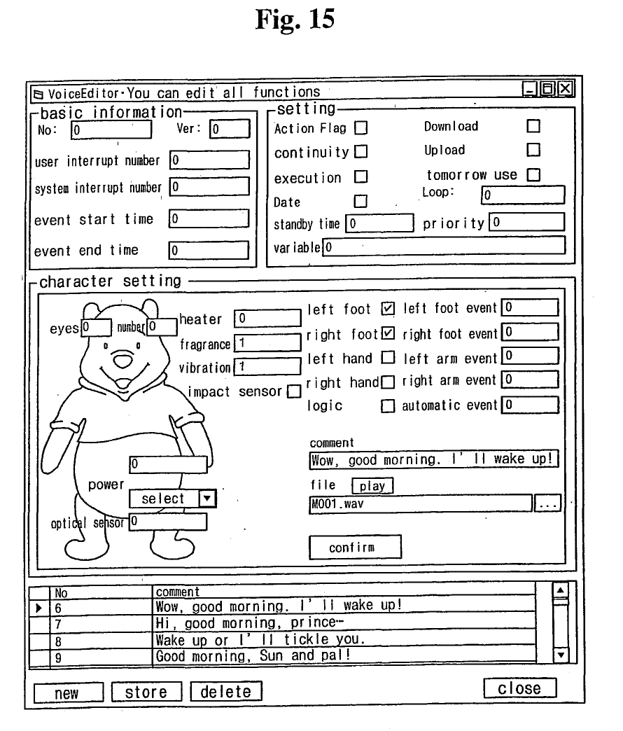

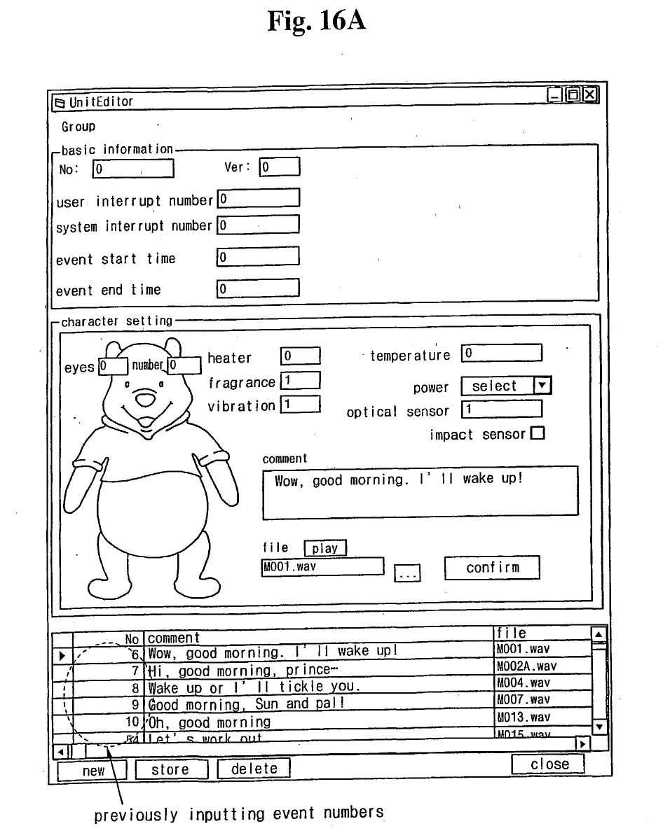

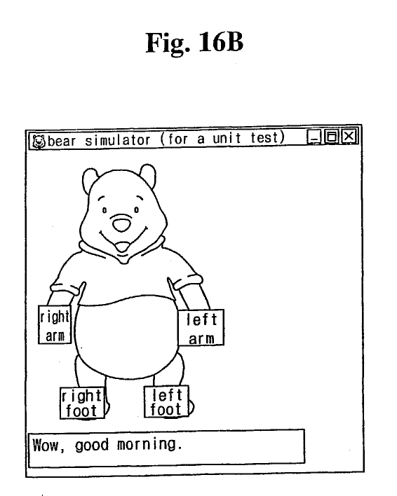

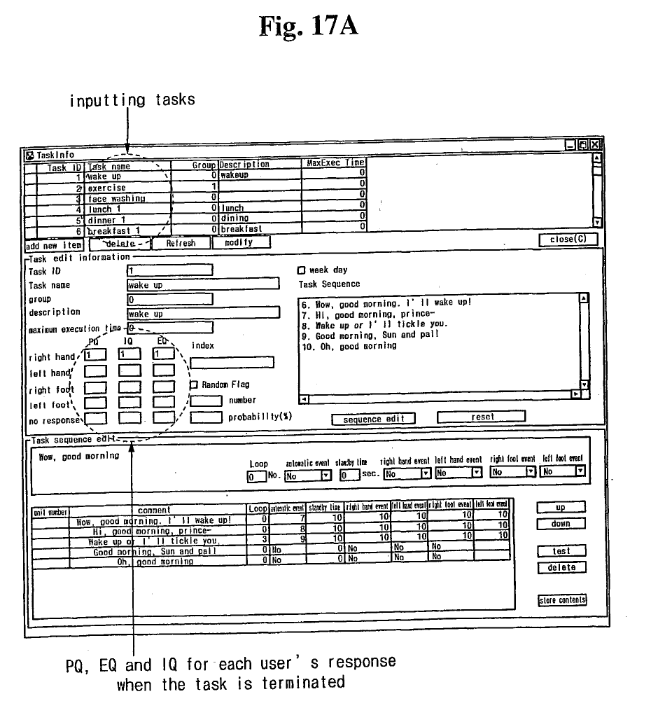

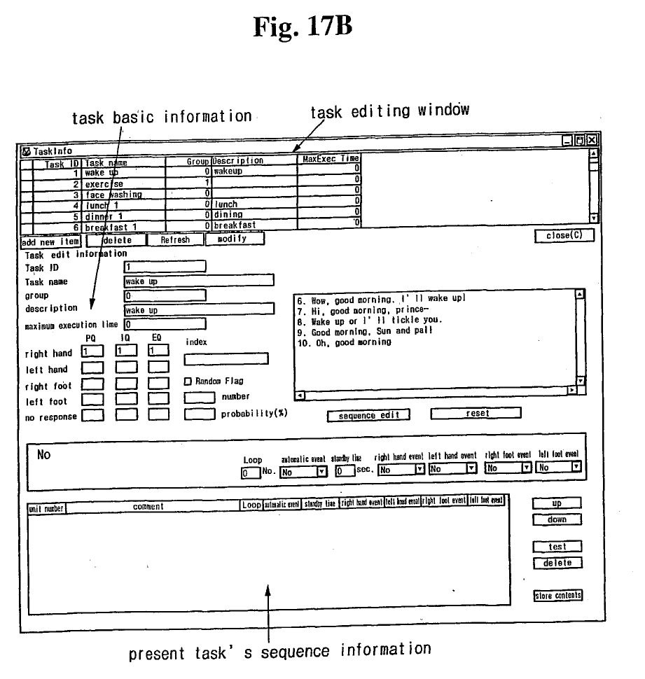

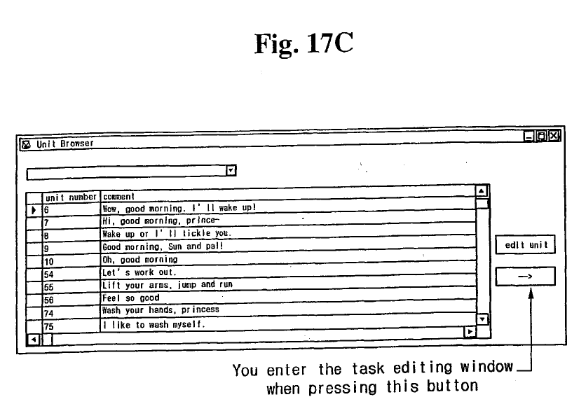

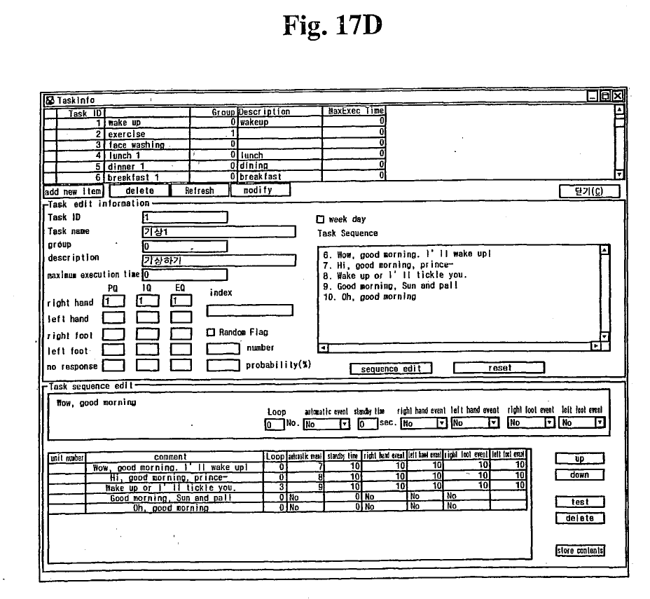

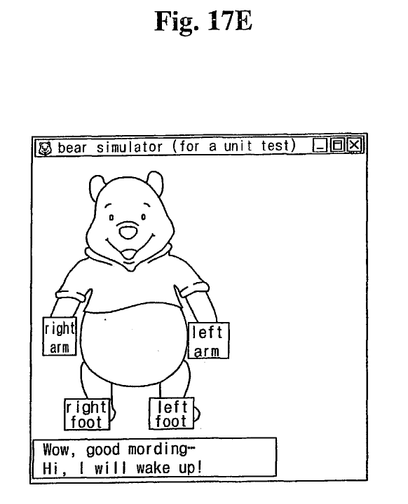

FIG. 15 shows a screenshot of a window for editing voices using an event editor, FIGS. 16(a) and 16(b) show screenshots of windows for editing an event unit using the event editor, and FIGS. 17(a) to 17(e) show screenshots of windows for editing tasks using the event editor.

The manager installs an event editor 1100 by running the execution file ‘setup.exe’ and an EventEditor icon in the EventEditor group on the program menu.

The database includes files ‘EventDB.MBD’ and ‘TaskList.MDB’ in the installation directory.

The data menu displayed on the main screen of the event editor includes four menus of a voice editor, an event unit editor, a task editor and a sound directory setting.

The manager can edit all contents of respective events via the voice editor. When the manager selects the voice editor menu, a window screen as illustrated in FIG. 16 is displayed on the manager computer 1000. The manager initially sets positions of sound files using a sound directory setting menu of the data menu. The manager must assign the position of the sound files to the position where files having a ‘wav’ extension exist. Since the sound files are frequently referred during the total editing process, their positions must be initially established. When assigning the position of the sound files, subsequent sound files are stored in the established position, and hence, no further assignment is needed,

Next, when the manager selects the event unit editor menu, a window screen for selecting a database that stores the event database. In this instance, when the manager selects the event database file in the event database selection menu, a window screen of the unit editor as shown in FIG. 17(a) is displayed. The manager inputs data using the unit editor. When the manager presses a ‘new’ button, a new row is created and the manager inputs a identification number in the basic information blank. When the manager returns to the previous window after the inputting, he can input desired data. In the case of a comment file, the manager presses a predetermined button to select a desired wave file and inputs the contents of the voice file in the comment item. When the manager inputs values corresponding to the event and presses a confirm button, a window for testing is displayed as shown in FIG. 17(b).

When the manager selects the task editing, a window for asking a task database is displayed, and the manager selects the task database in the like manner of the event database case. When the manager selects the task database, a task editing window is displayed to edit the task. If the event database is not established, a message window for selecting the event database is opened. When the manager selects a corresponding task list, a window as shown in FIG. 17(a). The manager inputs task contents, a task ID, a task title, group and description. A random flag indicates that the corresponding task will be randomly performed. In this instance, the manager inputs a number and rate of the randomness, and inputs a task category to the index. The manager marks on the window screen of FIG. 17(a) whether the corresponding task will be generated on weekdays or holidays. When the manager inputs a task, a window as shown in FIG. 17(b) is displayed. The manager inputs information on the task and selects an editor to edit the event included in the task, and then, a unit browser as shown in FIG. 17(c) is displayed, and a list of units generated by the previous unit editor. When the manager brows, finds and selects a desired unit and presses an arrow key, a task list editing window is opened. When the manager inputs information on the task, a window as shown in FIG. 17(d) is displayed, and when the manager presses a editing button, he can edit sequence information on the current task. After this, the manager inputs an event, a standby time and a repetition number fitting the corresponding task list. In this instance, the manager sets the event in various ways. For example, if the initial character task event is related to a wake-up, a comment of ‘Wow, good morning . . . ’ is previously set, and when the user responds to the character, an event for outputting the morning greeting is set, and if the user does not respond, the event is set to re-output another greeting of ‘Hi, good morning.’ The manager sets various events and stores them, and the set event data are stored in the respective event tables.

The manager uses up and down direction buttons to edit a sequence. When the manager inputs all information and presses a test button, a task simulator is operated and the manager can preview the corresponding operation on the window of FIG. 17(e). After the preview, a completion message is displayed. When the manager edits the task contents and presses a store button, the edited contents are stored in the database. When desiring to return to the previous step, the manager presses a set button.

When the manager sets the task contents and stores the same, the event editor processor 3300 calls the data processor 3400 and stores the task contents set by the manager in the event database 4300. The event editor 1100 can further comprise various menus as well as the above-described four items. The present invention is not restricted to the preferred embodiment of the present invention.

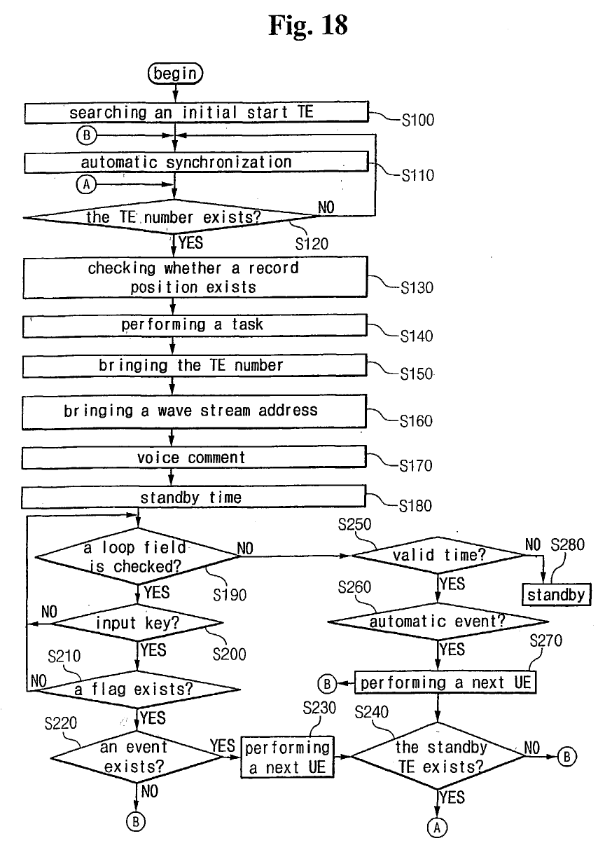

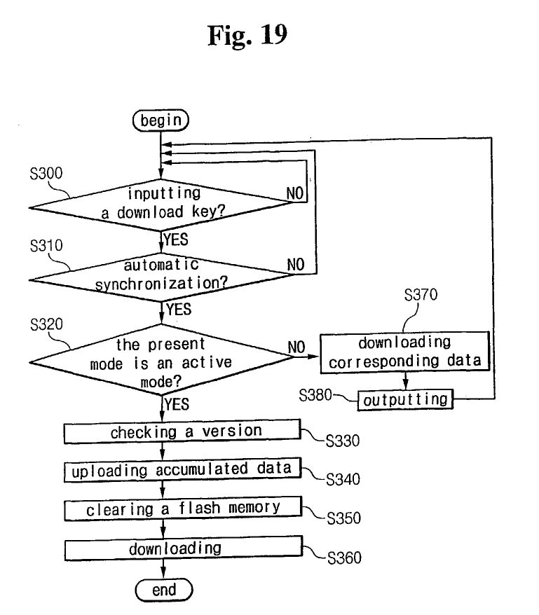

FIG. 18 shows a flowchart for downloading and uploading information according to the second preferred embodiment of the present invention, and FIG. 19 shows a flowchart of an information providing method using a character according to the second preferred embodiment of the present invention.

First, the user turns on the user computer 5000 and executes a web browser to be connected to the Internet 2000, and inputs a uniform resource locator (URL) to connect to the character management server 3000 to the web browser. The web browser requests an access from the character management server 3000 according to the URL input by the user, and when receiving the access request, the web page linker 3100 of the character management server 3000 displays a homepage to the web browser of the user computer 5000 according to the user's access allowance. When the user connects a universal serial bus (USB) cable connected to the user computer 5000 with the first connector of the character, an application or a web program on the homepage checks whether a serial port is connected. The character CPU 6230 of the character 6000 responds to the serial port checking. When the application or the web program on the homepage requests a serial number of the character, the character CPU 6230 transmits the serial number to the authenticator 3200. The authenticator 3200 receives the serial number and authenticates the character possessed by the user. In this instance, the authenticator 3200 calls the data processor 3400 to search information stored in the user database 4100 and performs an authentication using the searched results. After the authentication, the web page linker 3100 moves to a user homepage that corresponds to the character 6000 possessed by the user. The movement to the user homepage can be performed via a user log-in, and in this instance, the authenticator 3200 authenticates via a user ID and a password, and moves to the user homepage according to authentication results, which is not restricted to the preferred embodiment.

When it comes to a predetermined time, the character CPU 6230 searches the initial start task event (TE) stored in the memory 6100 in step S100. The character CPU 6230 automatically synchronizes the task event start time so as to start the task event in step S110. The character CPU 6230 determines whether an address number of the task event exists in step S120, and when the address number is found, the character CPU 6230 checks the event table's record position using the start time and the valid time period recorded in the table of the task event index in step S130. When the record position is checked, the character CPU 6230 executes the task that starts from an address number, that is, a record position transmitted to the task event index table from the event table (the voice database) in step S140. In this instance, the character CPU 6230 brings the event number that exists in the event table in step S150, stores various data via the data inputting and outputting, performs them and brings the address number of the wave stream in step S160. The character CPU 6230 calls the voice file from the wave stream start address number of the event table to the wave stream end address number and starts a voice comment via the speaker in step S170. The character CPU 6230 stands by while waiting for the user's response in step S180.

The character CPU 6230 checks a loop field for repeating the character's actions in step S190, and if the loop field exists in the event table, the character CPU 6230 determines whether an input key according to the user's response exists during the standby time in step S200. The user hears the voice file via the speaker and responds in many ways. For example, when the user hears a voice in relation to climate such as ‘Good morning, Hi, I will wake up.’ from the speaker, the user presses the right or left button of the character 6000 according to the output voice.

The character CPU 6230 determines whether an action flag exists when the input key according to the user's response exists in step S210. Here, the action flag represents a previously set bit (or bits) for memorizing something or leaving a predetermined signal to another program.

The character CPU 6230 determines whether an event exists in the event table in step S220, and when another event exists, the character CPU 6230 executes a subsequent unit event (UE) in step S230. The character CPU 6230 checks whether a standby task event that is not executed by the user exists during a standby time period after a task event executed by the start time in step S240, and if a standby task event exists, it returns to the step S120 of checking the existence of the task event address. For example, when a task event for a dinner of one hour of the valid time period is performed, the user does not input a key manipulation during the dinner time, and the user presses various buttons of the character 6000 to respond to the character 6000 within the one-hour's valid time period after finishing the dinner, the character CPU 6230 executes the valid task events for an hour and outputs a voice. If the valid standby task event does not exist during the valid time period, it returns to the initial time synchronization step S10.

If the loop field stored in the current event table does not exist in the loop field checking step S190, the character CPU 6230 checks the valid time period in step S250, and determines whether an automatic event that exists in the event table exists in step S260. When it exists, the character CPU executes a subsequent unit event in step S270. When the execution of the subsequent unit event is completed, the character CPU determines whether a standby task event exists in step S240. When the valid time period is checked in step S250, and the user does not respond, the character CPU stands by during the valid time period in step S280. Response values generated by the user via the character 6000 are stored in a flash memory (or a RAM).

As shown in FIG. 19, the user downloads a schedule-managing user program via the character 6000 after accessing the user homepage via the Internet 2000.

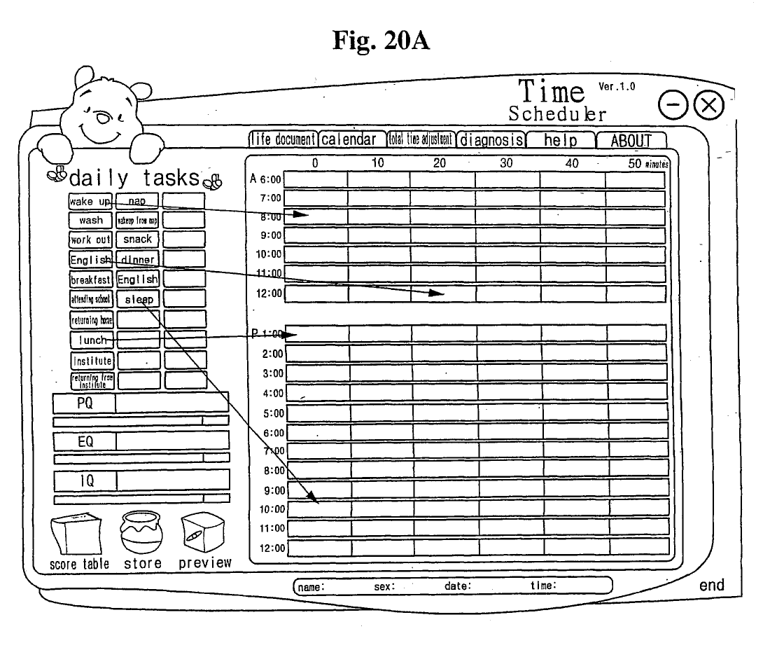

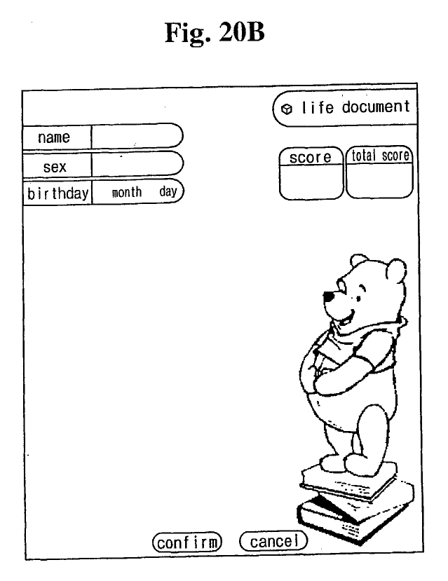

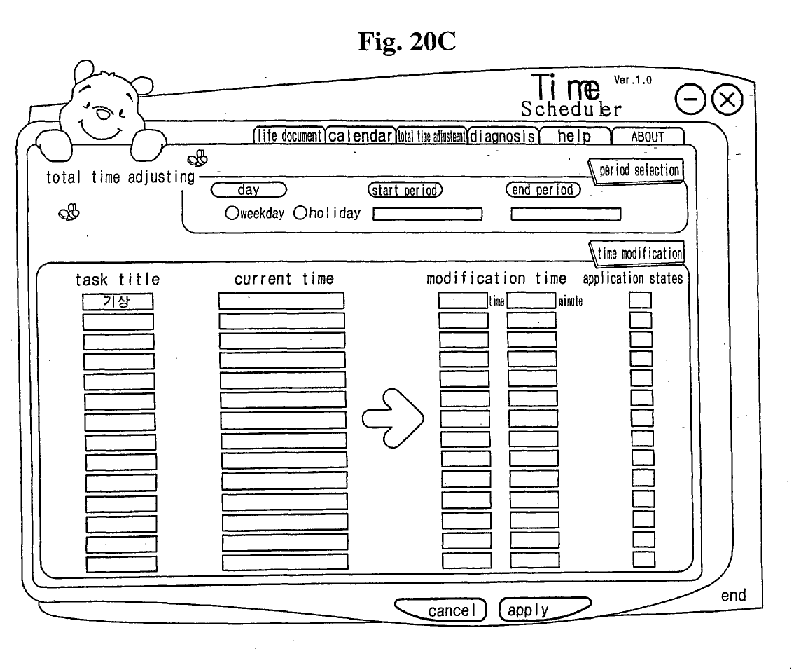

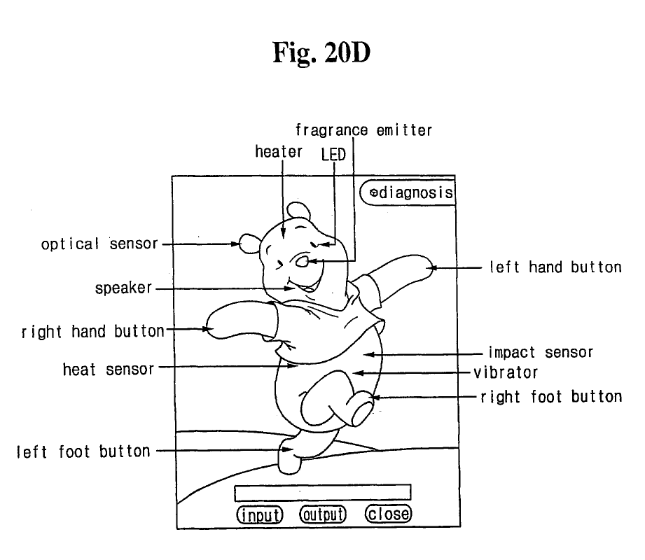

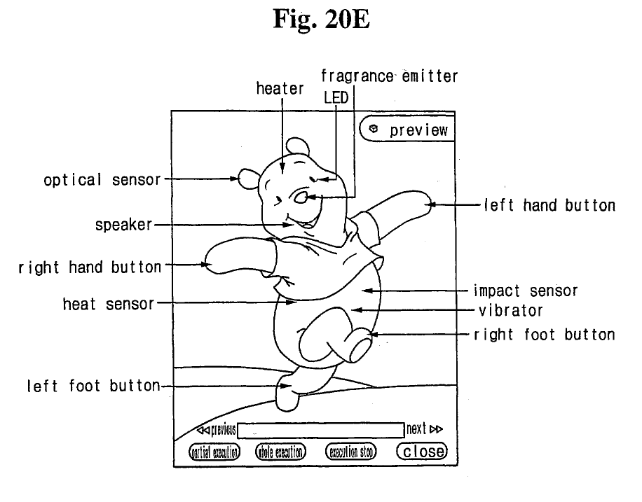

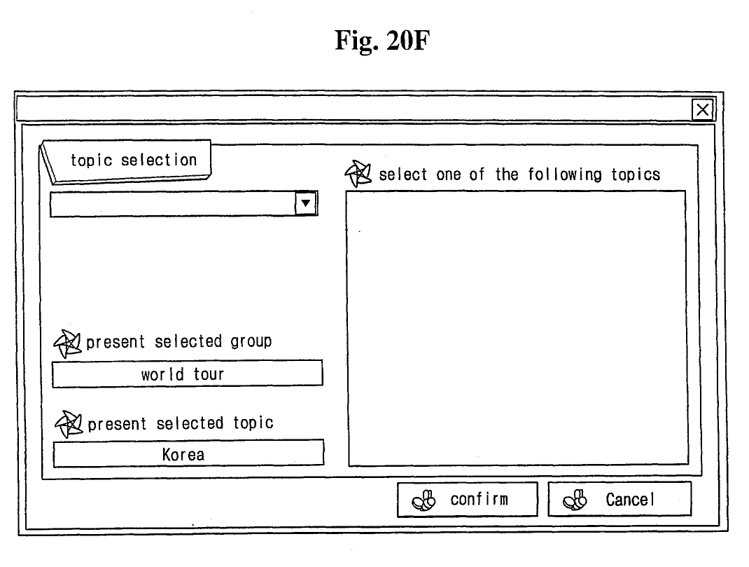

FIGS. 20(a) to 20(f) show an exemplified execution of a user program for a user to manage the user's schedule.

The user installs the user program downloaded to the user computer 5000 via the Internet 2000, and sets it so that the character 6000 may respond to the user's schedule via the window of FIG. 21(a). For example, when a child keeps the character 6000 and responds to the voice output by the character 6000, a user sets the child's timetable such as wakeup, exercise and breakfast to the character 6000 so that the child can lead a regular life style.

That is, when the user installs the user program, a TSH file as shown in FIG. 20(a) set by the manager is displayed, and the user reads the schedule on the TSH file, and modifies the schedule if needed. For example, when the user drags a desired button (e.g., wakeup, washing a face, exercises, breakfast, learning English, lunch, snack, nap, dinner and sleeping) and drops it on a desired blank of desired time using a mouse, a task for the character 6000 to do on the established time is set and stored. In this instance, the TSH file is set again and stored in the user program's database. When the user selects a user life document a window as shown in FIG. 20(b) for displaying information between the character and the user is displayed, and data stored using the character are uploaded, and when the data processor 3400 analyzes the uploaded data and converts a score and downloads it, the score is displayed on the score blank as shown in FIG. 20(b). The score is differently provided according to the user's response results, and the character's quotients such as health, emotion quotient and intelligence quotient are determined, and accordingly, effects such that the user raises the character 6000 like a pet can be generated.

As shown in FIG. 20(c), the user can select a total time adjustment region, totally selects the menus set by the manager and modify the same. The user selects either a weekday or a holiday, sets the start day and the end period, and selects a period to be modified. The current time is basically set by the manager via the event editor 1100, but the user can review the basic setting, modify the current time and clicks an apply button.

The user can select a diagnosing region and check whether the character's sensor and button are normally working under the state that the character is connected via the serial cable. When the user clicks a desired portion of the character picture as shown in FIG. 20(d), the character generates a response and displays the current states along with a corresponding comment in the text blank. The user can select a client region modification region (not illustrated) and modifies and manage the user information.

Also, the user can selects a preview region, sets a daily schedule and hear the story told by the character, that is, the data contents to be downloaded.

FIG. 20(e) shows a screen displayed on the user computer 5000 when the user selects a topic preview region. The initial screen displays a topic desired by the user, and when the user selects downloading, the corresponding downloading shown by the download flow is executed. When the user selects a topic selection region of FIG. 20(f), a screen for selecting at least one topic is displayed, and the user selects desired topics to be included in the daily task and accordingly, the user can download the same. Additional categories for performing various additional functions can be added to the above-noted user program, which is not restricted to the preferred embodiment of the present invention.

When the user computer 5000 is connected to the character management server 3000 via the Internet 2000, the user computer 5000 and the character 6000 are connected via the USB cable, and the user performs the user program, the character CPU 6230 checks the user's download key input on the window displayed by the user program in step S300. When the key input is provided by the user, the character CPU 6230 checks the automatic synchronization on the data to be downloaded and received in step S310. The character CPU 6230 checks whether the current mode is either an active mode or a direct index mode in step S320. If the current mode is found to be the active mode, the character CPU 6230 checks the version of the data made by the event editor 1100 in step S330. If the version of the data is found to be a previous one, the character CPU updates the version to receive new version data.

After checking the version, the character CPU 6230 uploads the accumulated data according to the user's response, stored in the flash RAM in step S340. In this instance, the uploaded accumulated data of the user response are transmitted to the data processor 3400 via the user computer 5000 and the Internet 2000. The data processor 3400 stores the accumulated data in the user response result database 4400. When uploading the accumulated data is completed, the character CPU 6230 clears the flash memory in step S350. When clearing the flash memory is completed, the user computer 5000 downloads the daily task event data set by the manager to the user computer in step S360, and the downloaded data are stored in the memory 6100 via the USB port.

In the mode determination step S320, if the current mode is not the active mode but the direct access mode, the task event data are downloaded in step S370, and the downloaded data are output via the character 6000 in the above voice outputting method in step S380.

The result data responded by the user are transmitted to the data processor 3400 via the user computer 5000 according to the uploading step, and the data processor 3400 stores the transmitted user response result data in the user response result database 4400 of the database server 4000. According to the analysis of the stored user response results, the user's tendency and schedule management ability are found, and the task event data provided to the character 6000 are modified according to the analyzed data.

In particular, the task event data provided by the event editor 1100 are not standardized and can be modified using the user program, and the user can operates the character 6000 according to the user's schedule so as to manage the schedule. Also, the user can connect the present invention to education programs to operate the character 6000 so as to apply the present invention to children education.

Also, the schedule management, alarming and various additional functions can be provided to the character having the appearances of famous stars, and various advertisements can be provided via the character.

As described, the information providing system and method using the character enables the user to nurse the character, provides various kinds of information selected by the user to the user via the character so as to satisfy the user, continuously updates the contents configuration via the human-friendly character, and stores the data needed by the user so as to perform bi-directional information exchanges.

Also, since the present invention connects the character such as a doll to the wireless terminal's data communication terminal or a earphone/microphone terminal and notifies the user of the wireless terminal's various receipt and use states via the character with various unique voices, the present invention provides different products from the conventional wireless terminals and activates the wireless terminal markets.

Further, since the present invention provides unique personality to each character, the present invention provides additional information such as current topics, life, education and entertainment to each character in a unique voice corresponding to the letters of Korean, English, Japanese and Chinese and the features of the character so that the user can effectively use the wireless terminal.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A character connected to a user terminal, a manager terminal, a connection, server and a data storage server through a network, comprising:
a connector for receiving and interfacing one or more kind of task event information from the user terminal;
a memory storing operation information of the character transmitted by the connector, and user response result data to the character;
a character controller controlling execution of the task event stored in the memory, and uploading the user response result data stored in the memory through the connector; and
a driver representing the task event data responsive to a control signal of the character controller.

2. The character of claim 1, wherein the memory comprises:
a file allocation table storing formal file allocation table in one or more blocks;
a variable region storing variables in one or more blocks;
an interrupt index storing an interrupt, a test event index and a game event table in one or more blocks;
an event table downloading and storing a unit event corresponding to a predetermined period in a first mode;
a wave stream storing a voice file corresponding to the period in the first mode;
a temporary table field downloading and storing one or more unit events in a second mode;
a temporary wave stream field downloading and storing one or more wave voice files in the second mode; and
a residual region prepared for abnormal states of each storage region of the memory.

3. The character of claim 1, wherein the connector comprises:
an uploader uploading the user response result data and schedule data set by the user terminal to the user terminal; and
a first connector receiving the user response result data and the schedule data from the uploader and uploading the received data to the connection server.

4. The character of claim 1, wherein the driver comprises:
a fragrance emitter emitting fragrance through a nose of the character;
one or more sensors sensing brightness, darkness, temperature and impact on the character;
a vibrator representing response results of the character through the vibration;
a speaker outputting the voice represented in the wave stream;
a light emitting diode displaying blinking signals through eyes of the character;
a microphone receiving a voice signal from user;
a voice recognizer means recognizing the voice signal from the microphone; and
a heater emitting heat to the user.

5. An information providing system connected to one or more user terminals through a network, providing data to the user terminal to operate responsive to the provided data, comprising:
a manager terminal supporting one or more data inputs for the user to receive schedule management information and additional information through the character;
a character management server providing the schedule management information and additional information to the user terminal through the network, receiving user's action data responding to the character and processing the received data; and
an information storage server storing character's operation and one or more event data for the character's operation.

6. An information providing system of claim 5, wherein the character downloads one or more operation execution data to operate, stores user response result data to the character's operation, and uploads the stored data.

7. An information providing system of claim 5, wherein the management terminal comprises:
a task event index manager producing, modifying and removing contents in a task event index field;
a voice file manager producing, modifying, and removing voice contents in the voice file;
an event table manager allowing to make data in a event table and to modify and remove the data, on the basis of the produced voice file;
a file manager selecting a task event index, an event table and a voice file used during a predetermined period to make them into one file, and setting schedule of the character and service time;
a direct field manager managing contents executed in a direct access mode;
a topic manager adding, modifying and removing contents corresponding to the topics, and allowing a user to modify the contents after a predetermined basic time is set;
a game event table manager producing, modifying, and removing game contents for the user to manage the schedule through the game and to receive other information; and
an event editor enabling the user to manage one or more kinds of additional information.

8. An information providing system of claim 5, wherein the character management server comprises:
a cyber text linker receiving one or more cyber text request signals from the manager terminal or the user terminal, and outputting cyber text corresponding to the cyber text request signal to the manager terminal or the user terminal;
an authenticator authenticating the connection request from the manager or the user, and authenticating an identification number of the character when the character is connected to the user terminal;
an event editor processor receiving and processing data setting information set by the event editor, and providing the processed result to the manager terminal; and
a data processor calling the information storage server on the basis of the processed result by the event editor processor to store set data, and reading information stored in the information storage server when an information request signal is received.

9. An information providing system of claim 5, wherein the information storage server comprises:
a user database storing identification information and detailed information of one or more managers or user's of the character;
a character database storing character information sorted on the basis of serial numbers which are allocated to each character;
an event database storing schedule management information for operating one or more characters and other information; and
a user response result database storing user response result data responding to the operation of the character.

10. An information providing system of claim 5, wherein the user terminal comprises:
a schedule manager enabling the user to directly manage individual schedules through a user homepage, to download the managed schedule to the character, and to inform the character of the managed schedule thereby having a regular lifestyle;
an personal information manager receiving selected contents proper to the user's tendency;
a character information manager measuring a specific quotient on the basis of user response information received from the character; and
a user program enabling the user to select the topic, and to execute topic management to change operation time of the character.

11. A computer-readable medium containing a program comprising the step of:
installing a first program enabling to set operation of a character;
executing data editing for operating the character on a data menu displayed on a main display after the first program's installation; and
storing the edited data.

12. A computer-readable medium of claim 11, wherein the step of executing data editing comprises the steps of:
allowing a manager to select a voice editor menu;
allowing the manager to set a position of a sound file by appointing a position of a wave file in a sound directory setting menu; and
allowing the manager to store the sound file in the appointed position.

13. A computer-readable medium of claim 11, wherein the step of executing data editing comprises the steps of:
allowing a manager to select event unit editing thereby selecting an event database file;
allowing the manager to select a new region to input an identification number;
allowing the manager to select voice comments file to input contents of a voice file in the voice comments; and
allowing the manager to input data for an event thereby testing the input data.

14. A computer-readable medium of claim 11, wherein the step of executing data editing comprises the steps of:
allowing a manager to select a task database on the basis of the manager's task editing selection;
allowing the manager to execute the task editing;
allowing the manager to input task contents, a task ID, a task title, a task group and a task explanation when the event database is not set;
allowing the manager to input a number and ratio of randomness, and a task class;
displaying when a corresponding task happens;
allowing the manager to execute a unit browser, to select units from a unit list made by previous unit editor, and to execute editing for the task list;
allowing the manager to input an event, a standby time, and a repetition number proper to the corresponding task; and
allowing the manager to operate a test simulator to previously perform a corresponding operation.

15. A computer-readable medium containing a program comprising the steps of:
receiving predetermined tasks and data from a character information providing system through a network;
resetting the received tasks and data for the character to respond to the user's schedule; and
transmitting the reset data to the character information providing system.

16. A computer-readable medium of the claim 15, wherein the step of resetting comprises the steps of:
receiving data which are converted into a score by analysis of the character information providing system after user response result data stored in the character are uploaded, displaying the converted score;
allowing the user to modify a previously set portion in a bundle by menu selection;
allowing the user to diagnose an operation of the character on the basis of the set data;
allowing the user to set a schedule of a predetermined time and to previously preview data which the character will download; and
allowing the user to select a topic among one or more topics thereby downloading a topic contained in the schedule of the predetermined time.

17. An information providing method using an information providing system using a character which is connected to one or more user terminals through a network, and provides data to the character to enable the character to execute the provided data, comprising the steps of:
producing data for operating the character during a predetermined time and providing the produced data to the character through the user terminal;
allowing the character to operate using the provided data; and
receiving user response result data uploaded from the character through the user terminal.

18. The method of claim 17, wherein the step of providing the produced data comprises the steps of:
installing a first program which can set operation of the character;
allowing to execute data editing for operating the character in a data menu displayed on a main display after the first program's installation; and
storing the edited data in a information storage device.

19. The method of claim 18, wherein the step of allowing to execute the data editing comprises the steps of:
allowing the manager to select a voice editor menu;
allowing the manager to set the position of a sound file by appointing the position of a wave file in a sound directory; and
allowing the manager to store the sound file in the appointed position.

20. The method of claim 18, wherein the step of allowing to execute the data editing comprises the steps of:
allowing the manager to select event unit editing thereby selecting an event database file in a event database selection display;
allowing the manager to select a new region to input an identification number;
allowing the manager to select voice comments to input contents of a voice file in the voice comments; and
allowing the manager to input data for an event thereby testing the input data.

21. The method of claim 18, wherein the step of allowing to execute data editing comprises the steps of:
allowing the manager to select a task database on the basis of task editing selection;
allowing the manager to execute the task editing;
allowing the manager to input contents in a task, a task ID, a task title, a task group and a task explanation when the event database is not set;
allowing the manager to input a number and a ratio of randomness, and a task class;
displaying when a corresponding task happens;
allowing the manager to execute a unit browser, and to select units from a unit list made by a previous unit editor, and to execute editing for the task list;
allowing the manager to input an event, a standby time and a repetition number proper to the corresponding task list; and
allowing the manager to operate a test simulator to previously perform a corresponding action.

22. The method of claim 17, wherein the step of providing the produced data comprises the steps of:
allowing a user to execute the user program thereby enabling the character to check the download key input by the user;
checking an automatic synchronization on the data which will be downloaded and transmitted when the user download key input exists;
checking whether the present mode is a first mode or a second mode;
allowing the character to check the version of the data made by the first program if the present mode is found to be the first mode;
uploading accumulated data on the basis of the user response stored in the memory from the character and storing the same;
deleting the data stored in the memory; and
downloading daily task event data set by the manager through the user terminal.

23. The method of claim 22, wherein the step of checking the present mode further comprises:
downloading the task event data and outputting the downloaded data through the character if the present mode is the second mode.

24. The method of claim 17, wherein the step of allowing the character to operate comprises the steps of:
searching the initial start task event stored in a memory of the character on a predetermined time, and automatically synchronizing a task event start time to start the task event;
confirming a record location of an event table using a start time and a valid time period recorded in a task event index table when the address number of the task event exists;
executing the task started on the record position provided to the task event index table from the event table when the record position is confirmed;
calling an event number existing in the event table to store and execute data and calling an address of the wave stream;
calling voice files from a start address to end address of the wave stream in the event table to start voice comments through a speaker;
waiting for the user response to the character;
determining whether an event exists in the event table on the basis of user's response so as to execute a subsequent unit event; and
checking whether an unexecuted and waiting other task event exists or not.

25. The method of the claim 24, wherein the step of waiting comprises the steps of:
checking a loop field to execute repeated actions on the character operation;
determining whether an input key on the basis of user's response exists during a standby time when the loop field exists in the event table; and
determining whether an action flag exists when the key input on the basis of the user's response exists.

26. The method of the claim 25, wherein the step of checking the loop field comprises the steps of:
checking a valid time period to check whether an automatic event exists in the event table when a loop field in the present event table does not exist;
executing a subsequent unit event when the automatic event exists in the event table;
re-checking whether an unexecuted and waiting task event exists so as to check the user's response to the unexecuted task event during the valid time period when the subsequent event execution is completed; and
executing an unexecuted task event when the user's response to the unexecuted task event is detected.

27. The method of the claim 17, wherein the step of proving data comprises the steps of:
receiving a predetermined task and data from a character information providing system through the network;
resetting the received predetermined task and data in order for the character to respond to the user's schedule; and
transmitting the reset data to the character information providing system.

28. The method of claim 27, wherein the step of resetting comprises the steps of:
receiving data which are converted into a score by analysis of the character information providing system after a user response result data stored in the character is uploaded, and displaying the converted score when the user selects a user life document region;
allowing the user to modify a previously set portion in a bundle by a menu selection when the user selects a total time adjustment region;
allowing the user to diagnose the operation of the character on the basis of the set data;
allowing the user to set a schedule of a predetermined time and to previously see data which the character will download; and
allowing the user to select a topic among one or more topics thereby downloading a topic contained in the schedule of the predetermined time.

29. The method of claim 17, wherein the step of receiving the user response result data comprises the steps of:
storing the user response result data uploaded from the character in an information storage device;
analyzing user's response data on the basis of user's response stored in the information storage device, reproducing task event data on the basis of the analysis result, and storing the same in the information storage device; and
downloading the reproduced data stored in the information storage device into the character.

30. An information providing system using a character comprising:
a mobile terminal having a communication interface including a data communication terminal and a wireless communicator;
a server transmitting various kinds of additional information and an operation program to the mobile terminal through a repeater; and
a character peripheral device connected to the communication interface of, the mobile terminal, for updating the corresponding additional information and operation program from the server into a memory according to a predetermined period and unique personality, reading a predetermined specific voice stored in the memory on the basis of sensing a contact with a specific body of the character and call connection data, and outputting the same.

31. The information providing system using the character of claim 30, wherein the character peripheral device comprises:
a plurality of sensors provided on each body part of the character and sensing contact with each body part;
a memory storing various voices and operation control programs;
a wireless interface performing wireless communication with an adjacent other character to transmit and receive information stored in the memory;
a receiver wire or wirelessly connected to the mobile terminal, and downloading text/voice messages and mail from the server through the mobile terminal;
a controller determining data input to the receiver, reading a predetermined voice stored in the memory on the basis of the determined result, and controlling operation;
a fragrance emitter emitting specific fragrance responsive to a control of the controller when the message and mail are received from the receiver;
a voice output device outputting a voice read from the memory responsive to a control of the controller; and
a voice input device performing a call connection responsive to the operation of the sensor to receive the voice of the user when a terminating call voice is output from the voice output device.

32. The information providing system using the character of claim 31, wherein the receiver is a wireless receiver for receiving wireless data from the wireless communicator of the mobile terminal.

33. The information providing system using the character of claim 31, wherein the receiver is a wire interface for receiving data from a data communication terminal or an earphone/microphone terminal of the mobile terminal.

34. The information providing system using the character of claim 31, wherein the plurality of sensors comprise toggle switches or impact switches.

35. The information providing system using the character of claim 31, wherein the wireless interface uses one communication scheme among the wireless infrared-ray communication scheme, the Bluetooth communication scheme, and the radio frequency communication scheme.

36. The information providing system using the character of claim 31, wherein the memory periodically downloads and updates operation program and various voice data from the server.

37. The information providing system using the character of claim 30 or claim 31, wherein the character peripheral device further comprises a voice recognizer for recognizing the voice of the user to automatically perform a call connection to other mobile terminal responsive to the voice data stored in the memory.
